(19) United States
(12) Patent Application Publication
(10) Pub. No.: US 2026/0100375 A1
(43) Pub. Date: Apr. 9, 2026

(54) ELECTRODE ACTIVE MATERIAL AND BATTERY

(71) Applicant: TOYOTA JIDOSHA KABUSHIKI KAISHA, Toyota-shi (JP)

(72) Inventors: Jun YOSHIDA, Mishima-shi (JP); Hirofumi NAKAMOTO, Sunto-gun (JP); SO YUBUCHI, Sunto-gun (JP); Ryosuke FURUYA, Gotemba-shi (JP); Chikuen WONG, Mishima-shi (JP); Kazushige NOMOTO, Sunto-gun (JP)

(73) Assignee: TOYOTA JIDOSHA KABUSHIKI KAISHA, Toyota-shi (JP)

(21) Appl. No.: 19/194,460

(22) Filed: Apr. 30, 2025

(30) Foreign Application Priority Data
Oct. 4, 2024 (JP) 2024-175159

(51) Int. Cl. H01M 4/62; H01M 4/02; H01M 4/134; H01M 4/36; H01M 4/38; H01M 10/0525

(52) U.S. Cl. CPC H01M 4/623; H01M 4/134; H01M 4/364; H01M 4/386; H01M 10/0525; H01M 2004/021

(57) ABSTRACT

In the present disclosure, the problem is solved by providing an electrode active material obtained by agglomerating a plurality of primary particles with a binder, wherein: the primary particles are a Si-based active material containing a Si element; the binder is an organic polymer having a tensile modulus not less than 0.10 MPa and not more than 1100 MPa; a ratio of the binder relative to a total of the primary particles and the binder is not less than 1 weight % and not more than 20 weight %; and a particle size D₅₀ of the electrode active material is not less than 2.5 μm and not more than 20 μm.

### CROSS-REFERENCE TO RELATED APPLICATION

This application claims priority to Japanese Patent Application No. 2024-175159 filed on Oct. 4, 2024. The disclosure of the above-identified application, including the specification, drawings, and claims, is incorporated by reference herein in its entirety.

### BACKGROUND

### 1. Technical Field

The present disclosure relates to an electrode active material and a battery.

### 2. Description of Related Art

Batteries are being actively developed in recent years. For example, in the field of the automobile industry, batteries used for a battery electric vehicle (BEV), a plug-in hybrid electric vehicle (PHEV), or a hybrid electric vehicle (HEV) are being developed. A battery typically includes a positive electrode layer, a negative electrode layer, and an electrolyte layer disposed between the positive electrode layer and the negative electrode layer. Moreover, there is known, as an electrode active material, an active material containing a Si element (Si-based active material). For example, Japanese Unexamined Patent Application Publication No. 2024-017797 (JP 2024-017797 A) discloses a negative electrode for a secondary battery, the negative electrode containing composite particles that include a plurality of porous silicon particles and a binder.

### SUMMARY

Although the Si-based active material is a high-capacity active material, it has large volume change in charge and discharge. The large volume change in charge and discharge tends to result in occurrence of cracks in the electrode layers, and the occurrence of cracks tends to result in performance deterioration (for example, resistance increase and/or cycle characteristics deterioration) of the battery. Therefore, as to the Si-based active material, it is requested to restrain volume change due to charge and discharge.

The present disclosure is devised in view of the aforementioned circumstances, and a main object thereof is to provide an electrode active material capable of restraining volume change of an electrode layer.

[1] An electrode active material obtained by agglomerating a plurality of primary particles with a binder, wherein:
the primary particles are a Si-based active material containing a Si element;
the binder is an organic polymer having a tensile modulus not less than 0.10 MPa and not more than 1100 MPa;
a ratio of the binder relative to a total of the primary particles and the binder is not less than 1 weight % and not more than 20 weight %; and
a particle size D₅₀ of the electrode active material is not less than 2.5 μm and not more than 20 μm.

[2] The electrode active material according to [1], wherein the tensile modulus may be not more than 300 MPa.

[3] The electrode active material according to [1] or [2], wherein the binder may be at least one of poly(vinylidene fluoride-co-hexafluoropropylene) (PVdF-HFP), polyvinyl butyral (PVB), styrene-butadiene rubber (SBR), and an epoxy resin.

[4] The electrode active material according to any one of [1] to [3], wherein the primary particles may be porous particles.

[5] The electrode active material according to any one of [1] to [4], wherein the electrode active material may be a negative electrode active material.

[6] A battery including: a positive electrode layer; a negative electrode layer; and an electrolyte layer disposed between the positive electrode layer and the negative electrode layer, wherein
one of the positive electrode layer and the negative electrode layer contains the electrode active material according to any one of [1] to [5].

In the present disclosure, an effect of being able to obtain an electrode active material capable of restraining volume change of an electrode layer is obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view showing a battery in the present disclosure.

### DETAILED DESCRIPTION OF EMBODIMENTS

Hereafter, an electrode active material and a battery in the present disclosure will be described in detail.

### A. Electrode Active Material

The electrode active material in the present disclosure is an electrode active material obtained by agglomerating a plurality of primary particles with a binder. Moreover, the primary particles are a Si-based active material containing a Si element. In particular, the electrode active material in the present disclosure has features below. The binder is an organic polymer having a tensile modulus not less than 0.10 MPa and not more than 1100 MPa. A ratio of the binder relative to the total of the primary particles and the binder is not less than 1 weight % and not more than 20 weight %. A particle size D₅₀ of the electrode active material is not less than 2.5 μm and not more than 20 μm.

According to the present disclosure, since the tensile modulus of the binder (organic polymer), the ratio of the binder (ratio of the binder relative to the total of the primary particles and the binder), and the particle size D₅₀ of the electrode active material are in respective predetermined ranges, there is provided the electrode active material that can restrain volume change of an electrode layer.

In view of absorbing expansion and contraction of the Si-based active material, and then, at least partially preventing cracks of an electrode layer, it is being investigated to use the electrode active material (secondary particles, granulated active material) that is obtained by agglomerating the Si-based active material (primary particles) with the binder. Meanwhile, the inventors have found that, when such an electrode active material is used for a battery, there is a case where volume change of the electrode active material is not able to be sufficiently restrained. Further study on the cause has revealed that there is a possibility that the secondary particles are deformed due to densification pressing in production of an electrode layer and production of a battery. When all or some of the secondary particles are deformed due to the pressing, there is a case where gaps (spaces where neither the primary particles nor the binder exists) inside the secondary particles collapse, and there is concern that expansion and contraction of the primary particles in the battery are not completely absorbed. Moreover, when all or some of the secondary particles are deformed and cracked due to the pressing, there is concern that the structure of the secondary particles in the battery is not kept and expansion and contraction of the primary particles are not completely absorbed.

After intensive investigations by the researchers of the present disclosure, it has been found that, by adjusting the tensile modulus of the binder, the ratio of the binder, and the particle size D₅₀ of the electrode active material to be in respective predetermined ranges, deformation of the secondary particles and collapse of the gaps can be restrained even when pressing pressure is applied to the electrode active material, and volume change of the electrode layer can be excellently restrained.

### 1. Primary Particles

The primary particles in the present disclosure are a Si-based active material containing the Si element.

The primary particles (Si-based active material) may be a Si simple substance, may be an alloy containing Si as a main component (Si alloy), or may be a Si oxide. A ratio of the Si element in the Si alloy is, for example, not less than 50 mol % and not more than 95 mol %.

The primary particles may be solid particles. Otherwise, the primary particles may be porous particles having gaps inside. The Si-based active material that has gaps is herein referred to as porous Si. Having such gaps can be confirmed by scanning electron microscope (SEM) observation. Moreover, not being specifically limited, the porosity is, for example, not less than 4%, or may be not less than 10%. Moreover, the porosity may be, for example, not more than 40%, or may be not more than 20%. The porosity can be obtained, for example, by a procedure as below. First, a sectional image of the Si-based active material is acquired by a SEM. Silicon portions and gap portions in the obtained image are separated using image analysis software, and they are binarized. Areas of the silicon portions and the gap portions are obtained, and the porosity (%) is calculated from the expression below.

Porosity (%)=100×(Gap Portion Area)/((Silicon Portion Area)+(Gap Portion Area))

In the porous Si, a gap amount of gaps that have pore diameters not more than 50 nm is, for example, not less than 0.05 cc/g and not more than 0.30 cc/g. Moreover, a BET specific surface area of the porous Si is, for example, not less than 20 m²/g and not more than 200 m²/g.

Examples of a method of producing the porous Si include a method of producing an alloy of Li and Si (LiSi alloy), and next, removing Li from the LiSi alloy. For example, the LiSi alloy is obtained by mixing Li and Si. Examples of the method of removing Li from the LiSi alloy include a method of causing the LiSi alloy to react with a Li extracting material. Examples of the Li extracting material include alcohols, such as methanol, and acids, such as acetic acid.

The primary particles (Si-based active material) may be crystalline or may be amorphous. In the case of the crystalline substance, the Si-based active material typically has a Si crystal phase. Examples of the Si crystal phase include a diamond crystal phase. Typical Si contains the diamond crystal phase as the Si crystal phase. The Si-based active material may contain the diamond crystal phase as a main phase of the Si crystal phase.

Other examples of the Si crystal phase include a silicon clathrate crystal phase. The silicon clathrate crystal phase may be a silicon clathrate type I crystal phase, or may be a silicon clathrate type II crystal phase. In the silicon clathrate crystal phase, a plurality of Si atoms constitutes a polyhedron (cage) including pentagons and/or hexagons. The polyhedron internally has a space where a metal ion, such as a Li ion, can be included. By a metal ion being inserted into the space, volume change due to charge and discharge can be restrained. As the main phase of the Si crystal phase, the Si-based active material may contain the silicon clathrate type I crystal phase, or may contain the silicon clathrate type II crystal phase. Examples of a method of producing the silicon clathrate crystal phase include a method of producing a Na—Si alloy through reaction of Na and Si, and after that, firing the Na—Si alloy to remove Na from the Na—Si alloy.

Not being specially limited, the particle size D₅₀ of the primary particles is, for example, not less than 0.3 μm and not more than 5.0 μm.

Examples of the method of forming the porous Si (porous particles) include a method of producing a LiSi alloy through reaction of the primary particles (Si-based active material) as solid particles with metal Li, and after that, removing Li from the LiSi alloy. For example, the LiSi alloy is obtained by mixing the primary particles (Si-based active material) and metal Li. A molar ratio (Li/Si) of Li to Si is, for example, not less than 1.0, may be not less than 2.0, may be not less than 3.0, or may be not less than 4.0. Meanwhile, Li/Si is, for example, not more than 8.0. Examples of the method of removing Li from the LiSi alloy include a method of causing the LiSi alloy to react with a Li extracting material. Examples of the Li extracting material include: alcohols, such as methanol, ethanol, 1-propanol, 1-butanol, 1-pentanol, and 1-hexanol; and acids, such as acetic acid, formic acid, propionic acid, and oxalic acid.

Other examples of the method of forming the porous particles include a method of producing a MgSi alloy through reaction of the primary particles (Si-based active material) as solid particles with metal Mg, and after that, removing Mg from the MgSi alloy. For example, the MgSi alloy is obtained by heating a mixture of the primary particles (Si-based active material) and metal Mg. A ratio (Mg/Si) of Mg to Si is, for example, not less than 1.0, may be not less than 1.5, or may be not less than 2.0. Meanwhile, Mg/Si is, for example, not more than 6.0. Examples of the method of removing Mg from the MgSi alloy include a method of changing Mg in the Mg—Si alloy into MgO by heating the MgSi alloy in an inactive gas atmosphere containing oxygen, and after that, removing MgO with an acid solution. Examples of the acid solution include an aqueous solution containing hydrochloric acid (HCl) and hydrogen fluoride (HF).

Examples of obtaining the primary particles (clathrate Si) having the clathrate crystal phase include a method of mixing and heating Si and a Na source, such as NaH, to produce a Na—Si alloy, and heating the Na—Si alloy thereby to reduce the amount of Na in the Na—Si alloy then to produce the silicon clathrate crystal phase. The primary particles (porous clathrate Si) that has gaps and has the clathrate crystal phase can be produced by using the porous Si as the Si above.

### 2. Binder

The binder in the present disclosure is an organic polymer having a predetermined tensile modulus.

The tensile modulus of the binder (organic polymer) is not less than 0.10 MPa. The tensile modulus may be not less than 0.50 MPa, may be not less than 1.00 MPa, may be not less than 5.00 MPa, or may be not less than 10.00 MPa. Moreover, the tensile modulus is not more than 1100 MPa. The tensile modulus may be not more than 1000 MPa, may be not more than 800 MPa, may be not more than 300 MPa, may be not more than 100 MPa, or may be not more than 50 MPa. When the tensile modulus is too high, in other words, when the binder is too hard, it is considered that the binder tends to be cracked due to pressing or the like. In such a case, it is considered that the secondary particles are cracked caused by cracks in the binder and the structure of the secondary particles in the battery is not kept. This leads to consideration that an effect of restraining volume change is not sufficiently obtained. Moreover, when the tensile modulus is too low, in other words, when the binder is too soft, it is considered that the electrode active material is deformed due to pressing and gaps in the secondary particles tend to collapse. For example, the tensile modulus can be measured by a tension test in conformity with JISK7161. Moreover, for example, the tensile modulus can be adjusted by the type of the binder (organic polymer compound) mentioned later, the degree of polymerization, and the like.

The type of the binder in the present disclosure is not specifically limited as long as it is included in organic polymers that have the aforementioned tensile moduli. The organic polymers may be thermoplastic resins, or may be thermosetting resins. Examples of the thermoplastic resins include PVdF-HFP, PVB, and SBR. Examples of the thermosetting resins include epoxy resins. The electrode active material may contain a single kind of binder, or may contain two kinds or more of binders.

Moreover, the binder ratio in the present disclosure (ratio of the binder relative to the total of the primary particles and the binder) is not less than 1 weight %. The ratio of the binder may be not less than 3 weight %, may be not less than 5 weight %, or may be not less than 8 weight %. Moreover, the ratio of the binder in the present disclosure is not more than 20 weight %. The ratio of the binder may be not more than 18 weight %, may be not more than 15 weight %, may be not more than 13 weight %, or may be not more than 10 weight %. When the ratio of the binder is too low, it is considered that agglomeration of the primary particles is too weak, deformation and/or cracks of the electrode active material tend to occur due to densification pressing in a production step of the battery, and as a result, restraint of volume change is not sufficiently obtained. On the other hand, when the ratio of the binder is too high, it is considered that this results in too few gaps inside the secondary particles (spaces where neither the primary particles nor the binder exists). It is also considered that this results in less room, inside the secondary particles, that is able to absorb expansion and contraction of the primary particles, and the effect of restraining volume change is not sufficiently obtained. In particular, when the primary particles are porous Si, there is concern that gaps inside the primary particles are filled with the binder, and there is concern that restraint of volume change can be less attained.

### 3. Electrode Active Material

The electrode active material in the present disclosure can be regarded as secondary particles obtained by agglomerating the primary particles with the binder.

A particle size D₅₀ of the electrode active material in the present disclosure is not less than 2.5 μm. D₅₀ may be not less than 3.0 μm, may be not less than 5.0 μm, or may be not less than 10 μm. Moreover, the particle size D₅₀ of the electrode active material in the present disclosure is not more than 20 μm. D₅₀ may be not more than 18 μm, may be not more than 15 μm, or may be not more than 13 μm. When the particle size D₅₀ is too small, although it is considered that durability against pressing is excellent, it is considered that this results in less room, in the secondary particles, that is able to absorb expansion and contraction of the primary particles, and the effect of restraining volume change is not sufficiently obtained. Moreover, when the particle size D₅₀ is too large, it is considered that this results in more influence due to pressing, and deformation and/or cracks of the electrode active material tend to occur. Moreover, when the particle size D₅₀ is too large, it is considered that, since reaction unevenness occurs in the secondary particles and local expansion and contraction occur, the effect of restraining volume change is not sufficiently obtained.

D₅₀ of the electrode active material can be controlled by adjusting D₅₀ of the primary particles (Si-based active material) mentioned above. Moreover, for example, the control can be performed by adjusting conditions for a spray drying method mentioned later, such as a spray pressure, a slurry concentration, and a slurry feeding rate.

Not being specially limited, examples of a method of producing the electrode active material in the present disclosure include the spray drying method. The spray drying method is a method of drying by spraying slurry containing the primary particles, the binder, and a dispersion medium into a hot gas flow.

The electrode active material in the present disclosure is typically used for a battery. Although the electrode active material may be a positive electrode active material and/or may be a negative electrode active material, it is preferably the latter. This is because a battery with high capacity can be obtained.

### B. Battery

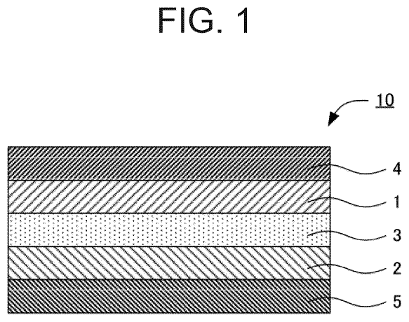

FIG. 1 is a schematic sectional view exemplarily showing a battery in the present disclosure. Notably, FIG. 1 is a schematic illustration, and sizes and shapes of portions therein are properly exaggerated for ease of understanding. A battery 10 shown in FIG. 1 includes a positive electrode layer 1, a negative electrode layer 2, an electrolyte layer 3 arranged between the positive electrode layer 1 and the negative electrode layer 2, a positive electrode current collector body 4 that collects electrons in the positive electrode layer 1, and a negative electrode current collector body 5 that collects electrons in the negative electrode layer 2. In particular, in the battery 10 in the present disclosure, the positive electrode layer 1 or the negative electrode layer 2 contains the electrode active material described in “A. Electrode Active Material” above. As mentioned above, the electrode active material in the present disclosure is preferably the negative electrode active material, in other words, the negative electrode layer preferably contains the aforementioned electrode active material. Hereafter, details of the battery in which the negative electrode layer contains the aforementioned electrode active material are described.

According to the present disclosure, since the positive electrode layer or the negative electrode layer contains the aforementioned electrode active material, there is provided a battery in which performance deterioration caused by cracks in an electrode layer is restrained.

### 1. Positive Electrode Layer

The positive electrode layer at least contains the positive electrode active material, and as needed, contains at least one of a conductive co-agent, a binder, and an electrolyte.

Examples of the positive electrode active material include layered rock salt-type active materials, such as LiCoO₂, LiNi_{0.8}Co_{0.15}Mn_{0.05}O₂, and LiNi_{0.33}Co_{0.33}Mn_{0.33}O₂, spinel active materials, such as LiMn₂O₄ and Li₄Ti₅O₁₂, and olivine active materials, such as LiFePO₄. Examples of a shape of the positive electrode active material include a shape of particles. A ratio of the positive electrode active material in the positive electrode layer is, for example, not less than 50 weight % and not more than 90 weight %.

Examples of the conductive co-agent include carbon materials. Examples of the carbon materials include: particulate carbon materials, such as acetylene black (AB) and Ketjen black (KB); and fibrous carbon materials, such as carbon fibers, carbon nanotubes (CNTs), and carbon nanofibers (CNFs). A ratio of the conductive co-agent in the positive electrode layer is, for example, not less than 0.5 weight % and not more than 10 weight %.

Examples of the binder in the positive electrode layer include the binder in the aforementioned electrode active material. Moreover, examples of the binder in the positive electrode layer include: polyimide-based binders; rubber-based binders, such as amine-modified butadiene rubber (ABR), butadiene rubber (BR), and styrene-butadiene rubber (SBR); cellulose-based binders, such as carboxymethylcellulose (CMC); acrylic binders, such as polyacrylic acid, polyacrylate salts, and polyacrylate esters; and fluoride-based binders, such as polyvinylidene fluoride (PVDF) and polytetrafluoroethylene (PTFE). A ratio of the binder in the positive electrode layer is, for example, not less than 0.5 weight % and not more than 10 weight %.

The electrolyte is described in “3. Electrolyte Layer”. Not being specially limited, a thickness of the positive electrode layer is, for example, not less than 0.1 μm and not more than 1000 μm.

### 2. Negative Electrode Layer

The negative electrode layer at least contains the negative electrode active material, and as needed, contains at least one of a conductive co-agent, a binder, and an electrolyte. Moreover, the negative electrode layer preferably contains the aforementioned electrode active material as the negative electrode active material. The matters described in “1. Positive Electrode Layer” apply to the conductive co-agent, the binder, and the electrolyte here.

Not being specially limited, a thickness of the negative electrode layer is, for example, not less than 0.1 μm and not more than 1000 μm.

### 3. Electrolyte Layer

The electrolyte layer is a layer arranged between the positive electrode layer and the negative electrode layer. The electrolyte layer at least contains an electrolyte, and as needed, may contain a binder. The matters described in “1. Positive Electrode Layer” apply to the binder.

Although the electrolyte may be a liquid electrolyte (electrolytic solution), or may be a solid electrolyte, it is preferably the latter.

Examples of the solid electrolyte include inorganic solid electrolytes, such as sulfide solid electrolytes, oxide solid electrolytes, nitride solid electrolytes, halide solid electrolytes, and complex hydrides. The sulfide solid electrolyte, the oxide solid electrolyte, the nitride solid electrolyte, and the halide solid electrolyte typically contain sulfur(S), oxygen (O), nitrogen (N), and halogen (X), respectively, as a main component of anion elements. Among these, the sulfide solid electrolyte is particularly preferably employed since the ion conductivity is high.

The examples of the solid electrolyte can also include organic solid electrolytes, such as polymer electrolytes and gelatinous electrolytes.

Examples of the electrolytic solution can include conventionally known electrolytic solutions used for lithium-ion batteries. Specifically, the examples can include electrolytic solutions containing: lithium salts, such as LiPF₆; and non-aqueous solvents, such as ethylene carbonate (EC), dimethyl carbonate (DMC), and ethyl methyl carbonate (EMC).

The electrolyte layer may be a solid electrolyte layer containing the aforementioned solid electrolyte. On the other hand, when the aforementioned electrolytic solution is contained as the electrolyte, the electrolyte layer may be a layer obtained by impregnating a separator with the electrolytic solution. A material of the separator may be an organic material, or may be an inorganic material. Specifically, examples thereof include porous membranes of polyethylene (PE), polypropylene (PP), cellulose, polyvinylidene fluoride, polyamide, and polyimide, nonwoven fabric, such as resin nonwoven fabric and glass fiber nonwoven fabric, ceramic porous membranes, and the like. Moreover, the separator may have a single layer structure, or may have a laminate structure.

Not being specially limited, a thickness of the electrolyte layer is, for example, not less than 0.1 μm and not more than 1000 μm.

### 4. Other Configurations

The battery in the present disclosure preferably include a positive electrode current collector body that collects current of the positive electrode layer, and a negative electrode current collector body that collects current of the negative electrode layer. Examples of a material of the positive electrode current collector body include SUS, aluminum, nickel, iron, titanium, and carbon. Meanwhile, examples of a material of the negative electrode current collector body include SUS, copper, nickel, and carbon.

The battery in the present disclosure may further include a binding jig that exerts confining pressure on the positive electrode layer, the electrolyte layer, and the negative electrode layer along the thickness direction. In particular, when the electrolyte layer is the solid electrolyte layer, in order to form excellent ion conduction path and electron conduction path, the confining pressure is preferably exerted. For example, the confining pressure is not less than 0.1 MPa, may be not less than 1 MPa, or may be not less than 5 MPa. Meanwhile, for example, the confining pressure is not more than 100 MPa, may be not more than 50 MPa, or may be not more than 20 MPa.

### 5. Battery

Not being specially limited, the type of the battery in the present disclosure is typically a lithium-ion battery. Moreover, the battery in the present disclosure may be a liquid battery in which the electrolyte layer contains the electrolytic solution, or may be a solid-state battery in which the electrolyte layer contains the solid electrolyte. The solid-state battery may be a semi-solid-state battery, or may be an all-solid-state battery. In the present disclosure, the semi-solid-state battery is a battery in which the electrolyte layer has the solid electrolyte and a liquid component (for example, ionic liquid). In the present disclosure, the all-solid-state battery is a battery in which the electrolyte layer only has the inorganic solid electrolyte as the electrolyte. Moreover, although the battery in the present disclosure may be a primary battery, or may be a secondary battery, it is preferably a secondary battery among these. The reason is that this can be repeatedly charged and discharged and is useful for an in-vehicle battery.

Examples of applications of the battery include a power supply for vehicles, such as a hybrid electric vehicle (HEV), a plug-in hybrid electric vehicle (PHEV), a battery electric vehicle (BEV), a gasoline automobile, and a diesel automobile. In particular, it is preferably used as a power supply for driving of a hybrid electric vehicle (HEV), a plug-in hybrid electric vehicle (PHEV), or a battery electric vehicle (BEV). Moreover, the battery may be used as a power supply for movable bodies, other than the vehicles, (for example, a railway, a ship, and an airplane), and may be used as a power supply for electric devices, such as an information processing apparatus.

Notably, the present disclosure is not limited to the aforementioned embodiment. The aforementioned embodiment is exemplary illustration, and anything that has a substantially equivalent configuration to those within the technical concept disclosed in the claims in the present disclosure and attains the similar effect(s) is included in the technical scope in the present disclosure.

### Example 1

### Production of Primary Particles

Under an Ar atmosphere, 0.65 g of Si particles (Kojundo Chemical Laboratory Co., Ltd.) and 0.60 g of Li metal (Honjo Metal Co., Ltd.) were mixed in an agate mortar to afford a LiSi precursor. In a glass reactor under an Ar atmosphere, 1.0 g of the LiSi precursor and 125 ml of a dispersion medium (1,3,5-trimethylbenzene, Nacalai Tesque, Inc.) were mixed using an ultrasonic homogenizer (UH-50, SMT Co., Ltd.). The LiSi precursor dispersion liquid obtained after the mixing was cooled to 0° C., and 125 ml of ethanol (Nacalai Tesque, Inc.) as a Li extracting solvent was dropped to react for 120 minutes. After the reaction, 50 ml of acetic acid (Nacalai Tesque, Inc.) was further dropped to react for 60 minutes. After the reaction, the liquid and the solid reactant were separated by filtration under reduced pressure. The obtained solid reactant was dried at 120° C. for 2 hours to recover porous primary particles (porous Si).

### Production of Secondary Particles

The obtained primary particles (porous Si) and a binder (PVdF-HFP) were dispersed in dimethyl carbonate (Nacalai Tesque, Inc.) to be partially dissolved, affording a slurry. Notably, in this slurry, the content ratio of the binder (ratio of the binder relative to the total of the primary particles and the binder) was set to 20 weight %. This slurry was sprayed into a spray drier under a nitrogen gas atmosphere at 140° C. to be dried (spray drying method). By adjusting the spray pressure and the slurry feeding rate in the spray drying method, the secondary particles that had the particle size D₅₀ as shown in Table 1 were obtained. A tension test for the binder was herein performed to measure a tensile modulus, which was 0.62 MPa.

### Production of Battery for Evaluation

As mentioned below, a battery for evaluation was produced using the secondary particles above as the negative electrode active material.

Using an ultrasonic homogenizer (UH-50, SMT Co., Ltd.), 1.0 g of the secondary particles above, 0.04 g of a conductive material (VGCF, Showa Denko K.K. (Resonac Corporation)), 0.776 g of a sulfide solid electrolyte (LiI—LiBr-Li₃PS₄-based sulfide solid electrolyte, D₅₀=0.2 μm), 0.02 g of a binder (PVdF, Kurcha Corporation), and 1.7 g of butyl butyrate (Kishida Chemical Co., Ltd.) were mixed to produce a negative electrode slurry. The negative electrode slurry was applied onto a negative electrode current collector body (Cu foil) by a blade method, and was dried on a hot plate under conditions of 100° C. and 30 minutes. Thereby, a negative electrode having the negative electrode current collector body and a negative electrode layer was obtained.

Next, using an ultrasonic homogenizer (UH-50, SMT Co., Ltd.), 1.5 g of a positive electrode active material (LiNi_{0.8}Co_{0.15}Mn_{0.05}O₂), 0.023 g of a conductive material (VGCF, Showa Denko K.K. (Resonac Corporation)), 0.239 g of a sulfide solid electrolyte (LiI—LiBr—Li₃PS₄-based sulfide solid electrolyte, D₅₀=0.2 μm), 0.011 g of a binder (PVdF, Kureha Corporation), and 0.8 g of butyl butyrate (Kishida Chemical Co., Ltd.) were mixed to produce a positive electrode slurry. The positive electrode slurry was applied onto a positive electrode current collector body (Al foil) by a blade method, and was dried on a hot plate under conditions of 100° C. and 30 minutes. Thereby, a positive electrode having the positive electrode current collector body and a positive electrode layer was obtained.

Next, a sulfide solid electrolyte (LiI—LiBr—Li₃PS₄-based sulfide solid electrolyte), a binder (PVdF, Kureha Corporation), and a dispersion medium (butyl butyrate) were dispersed using an ultrasonic homogenizer to produce a slurry for solid electrolyte layers. The slurry was applied onto transfer foils (Al foils) by a blade method, and they were dried on a hot plate under conditions of 100° C. and 30 minutes. Thereby, the transfer foils each having the solid electrolyte layer were obtained.

The positive electrode and the transfer foil were stacked such that the positive electrode layer and the solid electrolyte layer faced each other. After these were pressed at a pressing pressure of 50 kN/cm and a temperature of 160° C. by a roll press machine, the solid transfer foil (Al foil) was peeled off, and these were stamped out to have a size of 1 cm². Thereby, a positive electrode stacked body was obtained. Next, the negative electrode and the transfer foil were stacked such that the negative electrode layer and the solid electrolyte layer faced each other. After these were pressed at a pressing pressure of 50 kN/cm by a roll press machine, the transfer foil (Al foil) was peeled off. Thereby, a negative electrode stacked body was obtained. Furthermore, the transfer foil was stacked on the solid electrolyte layer side of the negative electrode stacked body such that the solid electrolyte layer of the transfer foil faced the solid electrolyte layer side. After this stacked body was tentatively pressed at a pressing pressure of 100 MPa and a temperature of 25° C. by a single-axis planar press machine, the transfer foil (Al foil) was peeled off from the solid electrolyte layer, and these were stamped out to have a size of 1.08 cm² thereby to afford the negative electrode stacked body that had the additional solid electrolyte layer.

The positive electrode stacked body and the negative electrode stacked body having the additional solid electrolyte layer were stacked so as to face each other. This stacked body was pressed at a pressing pressure of 600 MPa and a temperature of 160° C. by a single-axis planar press machine to afford a battery stacked body. The obtained battery stacked body was interposed between two binding plates, and these two binding plates were fastened by fasteners at a confining pressure of 1 MPa to fix the distance between the two binding plates. Thereby, a battery for evaluation (all-solid-state battery) was obtained.

### Examples 2 to 10 and Comparative Examples 1 to 6

As shown in Table 1, at least one of the type of the binder, the tensile modulus, and the ratio of the binder (content ratio of the binder) was changed from those of Example 1. Moreover, in production of the secondary particles, by adjusting the condition(s) for the spray drying (at least one of the spray pressure and the slurry feeding rate), the secondary particles that had the particle size shown in Table 1 were obtained. Each of the batteries for evaluation was produced as with Example 1 except that these secondary particles were used as the negative electrode active material.

### Comparative Example 7

A battery for evaluation was produced as with Example 1 except that the porous Si was used as the negative electrode active material.

### Evaluation

By monitoring confining pressure variations of the batteries obtained in Examples 1 to 10 and Comparative Examples 1 to 7 using load cells, volume changes of the batteries and the electrode layers were evaluated. Specifically, initial charging to 4.55 V at 0.245 mA was performed, a confining pressure before the initial charging was subtracted from a confining pressure after the initial charging (after full charging), and thereby, each amount of confining pressure variation was calculated. They were relatively evaluated with the result in Comparative Example 7 being as a reference. Table 1 presents the results.

TABLE 1

| | | | | | Confining |
|---|---|---|---|---|---|
| | Binder | | | | Pressure |
| | | Tensile | | | Variation |
| | | Modulus | Content | D₅₀ | (Relative |
| | Type | (MPa) | (wt %) | (μm) | Value) |
| Example 1 | PVdF-HFP | 0.62 | 10 | 7.6 | 0.81 |
| Example 2 | | 0.62 | 5 | 7.4 | 0.88 |
| Example 3 | | 0.62 | 15 | 8.2 | 0.84 |
| Example 4 | | 0.62 | 10 | 17.4 | 0.84 |
| Example 5 | PVB | 153 | 10 | 7.1 | 0.87 |
| Example 6 | | 55 | 10 | 12.1 | 0.88 |
| Example 7 | | 12 | 10 | 7.6 | 0.88 |
| Example 8 | PVdF-HFP | 298 | 10 | 8.7 | 0.88 |
| Example 9 | | 23 | 10 | 7.8 | 0.84 |
| Example 10 | | 0.2 | 10 | 7.5 | 0.91 |
| Comparative | SBR | 0.09 | 10 | 8.2 | 0.97 |
| Example 1 | | | | | |
| Comparative | Epoxy | 3100 | 10 | 9.6 | 1.09 |
| Example 2 | Resin | | | | |
| Comparative | PVdF-HFP | 0.62 | 22 | 8.5 | 1.03 |
| Example 3 | | | | | |
| Comparative | | 0.62 | 10 | 21.2 | 1.09 |
| Example 4 | | | | | |
| Comparative | | 1233 | 10 | 10.1 | 1.03 |
| Example 5 | | | | | |
| Comparative | | 0.05 | 10 | 9.8 | 1.06 |
| Example 6 | | | | | |
| Comparative | — | — | — | 2.6 | 1.00 |
| Example 7 | | | | | |

As shown in Table 1, it was confirmed that, as compared with Comparative Examples 1 to 7, any of the Examples exhibited a small confining pressure variation and the volume variation of the electrode layers and the battery was able to be restrained with the electrode active material in the present disclosure. Here, it was confirmed, from the results of Example 3 and Comparative Example 3 and from the results of Example 4 and Comparative Example 4, that, even when the tensile modulus of the binder (hardness of the binder) was in the predetermined range, when the ratio of the binder and the particle size of the electrode active material were too large, the effect of restraining volume change was not sufficiently obtained. Meanwhile, from the results of Comparative Example 5 (tensile modulus: 1233 MPa) and Comparative Example 6 (tensile modulus: 0.05 MPa), even when the ratio of the binder and the particle size of the electrode active material were in the predetermined ranges, when the binder was too hard or too soft, the effect of restraining volume change was not sufficiently obtained. This implied that the tensile modulus of the binder exhibited a predominant role on restraining volume change.

What is claimed is:

1. An electrode active material obtained by agglomerating a plurality of primary particles with a binder, wherein:
the primary particles are a Si-based active material containing a Si element;
the binder is an organic polymer having a tensile modulus not less than 0.10 MPa and not more than 1100 MPa;
a ratio of the binder relative to a total of the primary particles and the binder is not less than 1 weight % and not more than 20 weight %; and
a particle size D₅₀ of the electrode active material is not less than 2.5 μm and not more than 20 μm.

2. The electrode active material according to claim 1, wherein the tensile modulus is not more than 300 MPa.

3. The electrode active material according to claim 1, wherein the binder is at least one of poly(vinylidene fluoride-co-hexafluoropropylene) (PVdF-HFP), polyvinyl butyral (PVB), styrene-butadiene rubber (SBR), and an epoxy resin.

4. The electrode active material according to claim 1, wherein the primary particles are porous particles.

5. The electrode active material according to claim 1, wherein the electrode active material is a negative electrode active material.

6. A battery comprising:
a positive electrode layer;
a negative electrode layer; and
an electrolyte layer disposed between the positive electrode layer and the negative electrode layer, wherein
one of the positive electrode layer and the negative electrode layer contains the electrode active material according to claim 1.
